(19) United States
(12) Patent Application Publication
(10) Pub. No.: US 2004/0194049 A1
(43) Pub. Date: Sep. 30, 2004

(54) Method and system for designing IC

(75) Inventor: Hidetaka Mizumaki, Matsusaka-shi (JP)

Correspondence Address: Keating & Bennett LLP, Suite 312, 10400 Eaton Place, Fairfax, VA, 22030, US

(73) Assignee: SHARP KABUSHIKI KAISHA, Osaka (JP)

(21) Appl. No.: 10/801,145

(22) Filed: Mar. 16, 2004

(30) Foreign Application Priority Data
Mar. 25, 2003 (JP) 2003-082895

(51) Int. Cl. G06F 17/50

(52) U.S. Cl. 716/17

(57) ABSTRACT

A method for designing a new IC based on IC designing information, including standard and custom library designing information and is stored in, managed by, and transmitted from, a manager, includes the steps of: (a) transmitting at least part of the IC designing information, including a portion of the standard library designing information, from the manager to a design terminal through the Internet; (b) getting the new IC designed by a user located at the design terminal on the at least part of the IC designing information; (c) transmitting newly designed IC information, including new IC testing information to evaluate the new IC, to the manager through the Internet; (d) getting the new IC evaluated by the manager based on the newly designed IC information; and (e) adding at least part of the newly designed IC information to the custom library designing information, thereby updating the custom library designing information.

This non-provisional application claims priority under 35 USC §119(a) on Patent Application No. 2003-82895 filed in Japan on Mar. 25, 2003, the entire contents of which are hereby incorporated by reference.

### BACKGROUND OF THE INVENTION

1. Field of the Invention

The present invention relates to a method for designing an application-specific integrated circuit (ASIC), a design manager, a computer terminal for designing (design terminal) and an integrated circuit (IC) designing system for use to design an ASIC, and a program product applicable for use in such a system or terminal.

2. Description of the Related Art

Various types of ICs are included in electronic appliances and other industrial products. The number of devices included in each of those ICs has been rapidly growing year after year. That is to say, each and every IC has been getting more and more densely packed recently. And the denser each IC gets, the larger the number of possible functions to be performed by that IC should be to fulfill specific users' needs. An IC like this, i.e., an IC to be designed and manufactured for various specific purposes, is called an ASIC.

Reflecting such trends, methods of designing ICs have been changing, too. In the past, an IC used to be designed as a mere combination of a number of general-purpose ICs. Recently, however, the designer needs to create his or her original IC such that the IC can perform any function as requested by the user. Such a technique of designing an application-specific IC is disclosed in Japanese Laid-Open Publication No. 2001-142932, for example.

An ASIC is normally designed and manufactured as a fruit of cooperation between an IC designer and a system manufacturer who is professionally engaged in manufacturing a custom-made IC designed by the IC designer. Such a system manufacturer will be referred to herein as an “ASIC manufacturer”. More particularly, first, the IC designer designs an IC either to its exact specifications or up to its basic logic design. Thereafter, the ASIC manufacturer actually produces the IC in accordance with the design specified by the IC designer. Accordingly, the IC designer usually has to design his or her IC by using a particular IC designing system that is either prepared or designated by the ASIC manufacturer.

In the conventional IC designing method proposed in Japanese Laid-Open Publication No. 2001-142932, however, the IC designer must handle too many IC designing systems to always ensure proper compatibility between those systems. For that reason, after having determined the specifications of the circuits to be integrated together and before actually designing the IC, the IC designer needs to pick an appropriate combination of IC designing systems. In other words, before starting to design the IC, the IC designer must check out whether the circuits to be integrated together operate properly or not. This is because otherwise he or she could not be sure whether or not the operation timing margins or the layouts of IC input and output pins can be merged with each other among various IC designing systems. This is why in designing an IC, the IC designer must test the operability of the IC using a field programmable gate array (FGPA), which is an IC of the type requiring downloading of circuit data.

Furthermore, if the operability of the IC is tested on an FPGA, the ASIC designing system to be used must be compatible with the designing system that was used to design the FPGA. In other words, candidate ASIC designing systems need to be narrowed to a certain degree when the FPGA designing system is determined. Consequently, the ASIC designing system cannot be chosen so freely.

### SUMMARY OF THE INVENTION

In order to overcome the problems described above, preferred embodiments of the present invention provide an IC designing method that allows an IC designer to design an IC conveniently and efficiently, and a design manager, a computer terminal for designing (design terminal), an IC designing system and a program product for use in the designing method.

An IC designing method according to a preferred embodiment of the present invention is a method for designing a new IC based on IC designing information transmitted from a manager. The IC designing information includes standard library designing information and custom library designing information and is stored in, and managed by, the manager. The method includes the steps of: (a) transmitting at least part of the IC designing information, including a portion of the standard library designing information, from the manager to a design terminal through the Internet; (b) getting the new IC designed by a user located at the design terminal in accordance with the at least part of the IC designing information; (c) transmitting newly designed IC information, including new IC testing information to evaluate the new IC, from the design terminal to the manager through the Internet; (d) getting the new IC evaluated by the manager based on the newly designed IC information; and (e) adding at least part of the newly designed IC information to the custom library designing information that is stored in the manager, thereby updating the custom library designing information.

In one preferred embodiment of the present invention, the step (c) preferably includes the step of transmitting new IC connection information, and the step (e) preferably includes the step of adding the new IC connection information as custom library connection information to the custom library designing information.

In another preferred embodiment, the method preferably further includes, after the step (d), the steps of: making new IC evaluation information based on a result of the evaluation; and adding the new IC evaluation information to the newly designed IC information. The step (e) preferably includes the step of adding the new IC evaluation information as custom library evaluation information to the custom library designing information.

In still another preferred embodiment, the step (a) preferably includes the step of transmitting at least a portion of the custom library designing information as the at least part of the IC designing information.

In yet another preferred embodiment, the step (a) may include the step of transmitting the custom library connection information as the at least part of the IC designing information.

Alternatively, the step (a) may include the step of transmitting the custom library evaluation information as the at least part of the IC designing information.

In yet another preferred embodiment, the step (e) may include the step of adding the new IC testing information as custom library testing information to the custom library designing information, and the step (a) may include the step of transmitting the custom library testing information as the at least part of the IC designing information.

In yet another preferred embodiment, the step (a) preferably includes the steps of: making the manager determine whether or not the given design terminal belongs among authorized design terminals and/or whether or not the given user belongs among authorized users; and transmitting the custom library designing information as the at least part of the IC designing information to the design terminal provided that the given design terminal is identified as one of the authorized design terminals and/or that the given user is identified as one of the authorized users.

In this particular preferred embodiment, the step of making the manager determine may include the step of identifying the given design terminal by an electronic authentication number that is uniquely given to each authorized design terminal.

In an alternative preferred embodiment, the step of making the manager determine may include the step of identifying the given user by an ID and/or a PIN that are/is uniquely given to each authorized user.

In yet another preferred embodiment, the step of transmitting the custom library designing information preferably includes the step of narrowing the authorized users to a minimum range.

In yet another preferred embodiment, if the manager has found the user not belonging among the authorized users, then the step (a) may include the step of transmitting the at least part of the IC designing information not including the custom library designing information at all.

In an alternative preferred embodiment, if the manager has found the user not belonging among the authorized users, then the step (a) may include the step of transmitting the at least part of the IC designing information not including at least a portion of the custom library designing information.

In another alternative preferred embodiment, if the manager has found the user not belonging among the authorized users, then the step (a) may include the step of transmitting the at least part of the IC designing information including the at least a portion of the custom library designing information.

In this particular preferred embodiment, if the manager has found the user not belonging among the authorized users, then the step (a) preferably includes the step of transmitting the at least part of the IC designing information, including the at least a portion of the custom library designing information, provided that the user pays an administrator of the manager and/or a designer of the custom library for the at least portion of the custom library designing information.

More specifically, if the manager has found the user not belonging among the authorized users and if the user is allowed to design the new IC by using the custom library designing information included in the at least part of the IC designing information, the method preferably further includes, after the step (c), the steps of: determining whether or not the new IC has been designed based on the custom library designing information; and if the new IC has been designed based on the custom library designing information, alerting the user to pay for the custom library designing information used.

A manager according to a preferred embodiment of the present invention preferably manages IC designing information. The manager preferably includes: standard library storing means for storing standard library designing information; and communication processing means for transmitting at least part of the IC designing information to a design terminal, which designs a new IC, through the Internet and receiving design information about the new IC from the design terminal through the Internet. The at least part of the IC designing information preferably includes at least a portion of the standard library designing information that has been read out from the standard library storing means. The newly designed IC information preferably includes new IC testing information to evaluate the new IC. The manager preferably further includes: library evaluating means for evaluating the new IC according to the newly designed IC information that has been transmitted from the communication processing means; custom library storing means for storing custom library designing information and for receiving the newly designed IC information from the communication processing means and adding the newly designed IC information to the custom library designing information, thereby updating the custom library designing information; and managing means for managing the custom library designing information and for determining whether or not at least a portion of the custom library designing information stored in the custom library storing means should be transmitted to the design terminal. If the managing means has decided that the at least the portion of the custom library designing information should be transmitted to the design terminal, then the managing means adds the at least the portion of the custom library designing information to the at least part of the IC designing information by providing the at least the portion of the custom library designing information for the communication processing means.

In one preferred embodiment of the present invention, the communication processing means preferably receives a request for the custom library designing information from the design terminal over the Internet and preferably forwards the request to the managing means. On receiving the request every time, the managing means preferably determines whether or not at least a portion of the custom library designing information stored in the custom library storing means should be transmitted to the design terminal.

A manager according to another preferred embodiment of the present invention is preferably used in the method according to any of the preferred embodiments of the present invention described above.

A design terminal according to a preferred embodiment of the present invention is preferably used to design a new IC based on IC designing information transmitted from a manager. The IC designing information preferably includes custom library designing information and is preferably stored in and managed by the manager. The design terminal preferably includes: means for receiving at least part of the IC designing information from the manager through the Internet; IC designing means for designing the new IC in accordance with the at least part of the IC designing information; and means for transmitting newly designed IC information, including new IC testing information to evaluate the new IC that has been designed by the IC designing means, to the manager through the Internet. The newly designed IC information that has been transmitted to the manager is preferably added to the custom library designing information that is stored in the manager.

A design terminal according to another preferred embodiment of the present invention is preferably used in the method according to any of the preferred embodiments of the present invention described above.

A program product according to a preferred embodiment of the present invention is preferably defined specially for the purpose of managing IC designing information by making a computer function as: standard library storing means for storing standard library designing information; communication processing means for transmitting at least part of the IC designing information to a design terminal, which designs a new IC, through the Internet and receiving design information about the new IC from the design terminal through the Internet, the at least part of the IC designing information including at least a portion of the standard library designing information that has been read out from the standard library storing means, the newly designed IC information including new IC testing information to evaluate the new IC; library evaluating means for evaluating the new IC according to the newly designed IC information that has been received at the communication processing means; custom library storing means for storing custom library designing information and for receiving the newly designed IC information from the communication processing means and adding the newly designed IC information to the custom library designing information, thereby updating the custom library designing information; and managing means for managing the custom library designing information and for determining whether or not at least a portion of the custom library designing information stored in the custom library storing means should be transmitted to the design terminal. If the managing means has decided that the at least the portion of the custom library designing information should be transmitted to the design terminal, then the managing means adds the at least the portion of the custom library designing information to the at least part of the IC designing information by providing the at least the portion of the custom library designing information for the communication processing means.

A program product according to another preferred embodiment of the present invention is preferably defined specially for the purpose of designing a new IC based on IC designing information, including custom library designing information and being stored in, managed by, and transmitted from, a manager, by making a computer function as: means for receiving at least part of the IC designing information from the manager through the Internet; IC designing means for designing the new IC in accordance with the at least part of the IC designing information; and means for transmitting newly designed IC information, including new IC testing information to evaluate the new IC that has been designed by the IC designing means, to the manager through the Internet. The newly designed IC information that has been transmitted to the manager is added to the custom library designing information that is stored in the manager.

An IC designing system according to a preferred embodiment of the present invention preferably includes the manager and design terminal according to any of the preferred embodiments of the present invention described above.

An IC designing system according to another preferred embodiment of the present invention is preferably used in the IC designing method according to any of the preferred embodiments of the present invention described above.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing a configuration for the main components of an IC designing system according to a preferred embodiment of the present invention.

FIG. 2 shows the data structure of a transport packet to be transmitted from the manager to the design terminal, or vice versa, in a preferred embodiment of the present invention.

FIG. 3 is a flowchart showing how the manager operates when newly designed IC information is transmitted from the design terminal to the manager in a preferred embodiment of the present invention.

FIG. 4 is a flowchart showing how the manager operates when a request for downloading IC designing information is transmitted from the design terminal to the manager in a preferred embodiment of the present invention.

### DETAILED DESCRIPTION OF PREFERRED EMBODIMENTS

In an IC designing method according to a preferred embodiment of the present invention, an IC designing system, including a manager and a design terminal, is used. The manager includes means for storing and managing IC designing information. The IC designing information includes standard library designing information and custom library designing information.

First, in step (a), at least part of the IC designing information is transmitted from the manager to a design terminal through the Internet. The IC designing information to be transmitted may be a portion of the standard library designing information, for example. In addition, at least a portion of the custom library designing information may be transmitted as well. Next, in step (b), a user, who is located at the design terminal, designs a new IC in accordance with that IC designing information. Thereafter, in step (c), information about the newly designed IC is transmitted from the design terminal to the manager through the Internet. This newly designed IC information includes new IC testing information to evaluate the new IC.

Subsequently, in step (d), the manager evaluates the new IC based on the newly designed IC information. Optionally, new IC evaluation information may be created based on the result of this evaluation. In that case, the new IC evaluation information may be added to the newly designed IC information. Thereafter, in step (e), the manager adds at least part of the newly designed IC information to the custom library designing information that is stored in the manager, thereby updating the custom library designing information. For example, the new IC testing information included in the newly designed IC information may be added as custom library testing information to the custom library designing information.

In the IC designing method according to this preferred embodiment of the present invention, information is exchanged between the manager and the design terminal over the Internet as described above. Accordingly, no matter where each IC design terminal is located, the manager can always manage the information about the designing activity that is being carried out by the design terminal. Also, any general-purpose personal computer may be used as the design terminal provided that the computer can access the Internet. In addition, in this preferred embodiment of the present invention, the manager evaluates the new IC. Accordingly, even if a custom library is included in the new IC, the new IC can also be evaluated without allowing designing information about the custom library to leak easily. Furthermore, every time a new IC is designed, the manager obtains information about the newly designed IC and adds the newly designed IC information to the custom library designing information, thereby updating the custom library designing information. In this manner, the IC designing information stored in the manager can be further broadened every time. The user located at the design terminal (i.e., an IC designer) is accessible to not only the standard library designing information but also the custom library designing information to be updated every time this IC designing system is used. Thus, he or she can design an IC even more efficiently. In addition, the standard library designing information and custom library designing information are stored in, and managed by, the manager, and therefore, cannot be deleted by the user at the design terminal (i.e., IC designer) either intentionally or unintentionally.

The newly designed IC information preferably includes new IC connection information (i.e., information about the layout of pins). The new IC connection information may be added as custom library connection information to the custom library designing information. When the custom library connection information is added to the IC designing information, the custom library designing information, including the custom library connection information, may be transmitted from the manager to the design terminal in the step (a). Receiving the custom library designing information including the custom library connection information, the user can imagine how the IC he or she is now designing will actually be like while connecting multiple IC designing libraries together on the computer screen.

In the step (a), the IC designing information transmitted to the design terminal may include custom library evaluation information. Receiving the custom library designing information including the custom library evaluation information, the user can confirm the reliability of the IC under design (e.g., the feasibility of timing relationship) by checking out the custom library evaluation information. Thus, the user can design his or her IC by using the custom library with confidence. Furthermore, the IC designing information transmitted to the design terminal may also include custom library testing information. Receiving the custom library designing information including the custom library testing information, the user can design his or her new IC with the custom library and without bothering to prepare testing information.

Optionally, the custom library designing information may be made invisible to (i.e., inaccessible for) anybody but authorized users (i.e., authorized IC designers). Alternatively, persons other than the authorized users may access just a portion of the custom library designing information. Also, the designer of an IC concerning the custom library designing information may sometimes not allow the disclosure of the custom library designing information at all. For that reason, multiple levels of access control may be defined for individual sets of custom library designing information.

Alternatively or additionally, the custom library designing information (or a portion thereof) may be made inaccessible from any design terminal other than authorized design terminals.

Such an access control may be carried out in the step (a) in the following manner, for example.

First, in step (a1), the manager may determine whether or not the given design terminal belongs among authorized design terminals and/or whether or not the given user belongs among authorized users. This authentication process step may be carried out by identifying the given design terminal by an electronic authentication number that is uniquely given to each authorized design terminal and/or by identifying the given user by an ID and/or a PIN that are/is uniquely given to each authorized user. Based on the result of this authentication process step, the manager transmits the IC designing information to the design terminal in step (a2). By making the manager identify the given design terminal and/or the given user to prohibit non-authorized design terminals or users from accessing the IC designing information in this manner, the overall number of accesses to, and the load on, the manager can be reduced.

If the manager has identified the given design terminal as one of the authorized design terminals and/or the given user as one of the authorized users in the step (a1), then the manager may transmit the IC designing information, including the custom library designing information, to the design terminal in the step (a2). On the other hand, if the manager has found the given design terminal not belonging among the authorized design terminals and/or the given user not belonging among the authorized users, the manager may transmit either no custom library designing information at all (i.e., transmit only the standard library designing information) or just a portion of the custom library designing information to the design terminal.

If the manager has found the given user not belonging among the authorized users in the step (a1), then the step (a2) may include the step of transmitting at least a portion of the custom library designing information to the design terminal being used by that user, provided that the user pays an administrator of the manager and/or a designer of the custom library for the at least portion of the custom library designing information. By allowing the user to access the custom library designing information contingent on the user's paying in this manner, a far greater number of designers will feed their designing information into the custom library designing information on this IC designing system. Then, the custom library designing information will be very much diversified, thus allowing the IC designers to design their ICs much efficiently.

The user preferably pays for the custom library designing information while assembling the components of his or her newly designed IC. That is to say, the user is preferably prompted to pay only when the IC that has been newly designed by him or her includes the custom library. In that case, the user does not have to pay for anything in an initial stage of the design process such as a logic simulation stage. Thus, the user can feel free to check the operability of his or her newly designed IC by reference to the custom library designing information. For example, after having received the newly designed IC information from the design terminal in step (c), the manager may determine whether or not the new IC has been designed based on the custom library designing information. If the new IC has been designed based on the custom library designing information, then the manager may find that the custom library designing information used now has to be paid for and may alert the user to pay for the custom library designing information used.

It should be noted that the charge for the custom library designing information is preferably determined by the designer of the custom library himself. Suppose a user designs an IC by using chargeable custom library designing information (with a charge A). In that case, if the user has designed an IC including the chargeable custom library and a new library, then the user determines only a charge B for the new library. When the newly designed IC information is added to the custom library designing information, the charge B for the new library is also listed. In this case, the charge A for the chargeable custom library is automatically listed by the manager. After this listing is completed, the user of this custom library designing information will pay the total charge of A+B, which does not have to be the exact sum of the charges A and B but may be reduced by discounting the charge A.

The manager preferably manages the custom library by narrowing the authorized users to a minimum range. Accordingly, in the step (a1), the manager preferably determines whether or not the given user belongs among the authorized users. Then, even if one of those authorized users designs an IC from a different computer terminal, not only the custom library designing information but also the information about the IC being newly designed by the user may be transmitted to the different computer terminal upon the user's request.

A manager according to a preferred embodiment of the present invention is preferably used for managing IC designing information and preferably includes standard library storing means for storing standard library designing information, communication processing means, library evaluating means for evaluating the new IC, custom library storing means for storing custom library designing information, and custom library managing means for managing the custom library designing information. The communication processing means preferably transmits at least part of the IC designing information to a design terminal, which designs a new IC, through the Internet and preferably receives design information about the new IC from the design terminal through the Internet. The IC designing information transmitted from the manager to the design terminal preferably includes at least a portion of the standard library designing information that has been read out from the standard library storing means. The newly designed IC information transmitted from the design terminal to the manager preferably includes new IC testing information to evaluate the new IC. The library evaluating means preferably receives the newly designed IC information from the communication processing means, thereby evaluating the new IC according to that information. The custom library storing means preferably receives the newly designed IC information from the communication processing means and preferably adds the newly designed IC information to the custom library designing information, thereby updating the custom library designing information. The managing means preferably determines whether or not at least a portion of the custom library designing information stored in the custom library storing means should be transmitted to the design terminal. If the answer is YES, then the managing means preferably provides the at least the portion of the custom library designing information for the communication processing means. In response, the communication processing means preferably transmits the IC designing information, including the at least the portion of the custom library designing information, to the design terminal.

On receiving the request for the custom library designing information every time, the managing means may determine whether or not at least a portion of the custom library designing information should be transmitted to the design terminal. For example, a user located at a design terminal inputs a request for the custom library designing information to the design terminal. The communication processing means receives the request from the design terminal over the Internet and then forwards the request to the managing means. And on receiving the request every time, the managing means determines whether or not at least a portion of the custom library designing information stored in the custom library storing means should be transmitted to the design terminal.

The manager according to this preferred embodiment of the present invention includes these means, and therefore, can manage the standard library designing information and custom library designing information and can function as a server for all design terminals. Accordingly, the manager not only manages the IC designing information but also can function as a server for doing an overall management on various other types of information including IC designers (users) information and information about the operating conditions of the respective design terminals.

A design terminal according to a preferred embodiment of the present invention preferably includes receiving means for receiving at least part of the IC designing information from the manager through the Internet, IC designing means for designing a new IC in accordance with the IC designing information received, and transmitting means for transmitting newly designed IC information, including new IC testing information to evaluate the new IC that has been designed by the IC designing means, to the manager through the Internet. The newly designed IC information that has been transmitted from the receiving means to the manager is preferably added to the custom library designing information that is stored in the manager.

The manager or the design terminal may be implemented either as hardware components or by introducing a software program into a computer. In the latter case, the program is preferably defined so as to make the computer function as the respective means of the manager or the design terminal. In other words, when such a program is run by the computer, the computer operates as the manager or the design terminal. It should be noted that the “programs” refer to herein not only programs to be directly executed by the computer but also programs to be executable after having been installed into a hard disk, for example. Also, the programs may be compressed or encoded as well.

Hereinafter, an IC designing method according to a specific preferred embodiment of the present invention will be described with reference to the accompanying drawings.

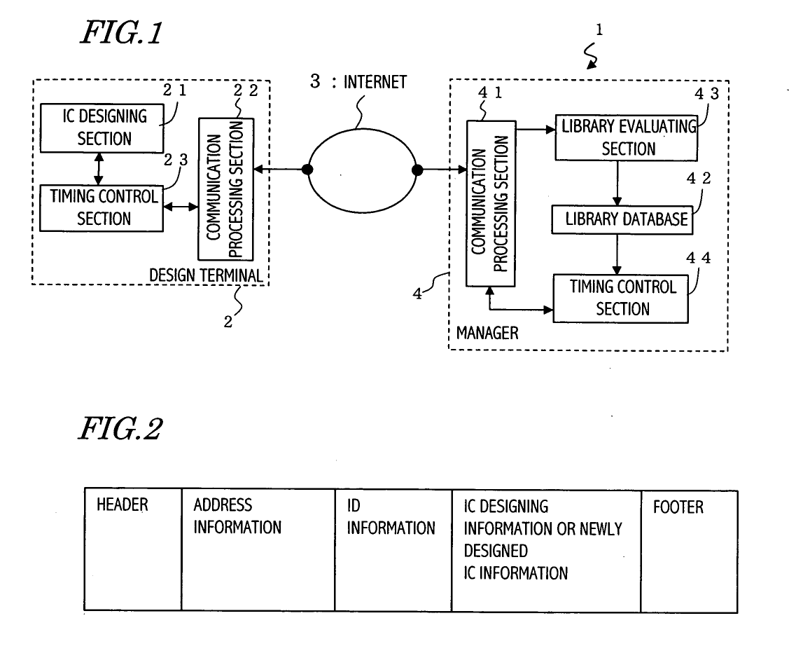

FIG. 1 is a block diagram schematically showing an overall configuration for an IC designing system according to this preferred embodiment. As shown in FIG. 1, this IC designing system preferably includes a manager 4 for managing the IC designing system and a design terminal 2. The manager 4 preferably transmits IC designing information to the design terminal 2 through the Internet 3. The user uses the design terminal 2 and designs an IC by using this IC designing system. Thereafter, the design terminal 2 transmits information about the newly designed IC (i.e., newly designed IC information) to the manager 4 over the Internet 3.

The IC designing information and newly designed IC information includes information about circuit diagrams themselves (which will be simply referred to herein as “circuit diagrams”), information representing the circuit diagrams in a language (which will be simply referred to herein as “language information”) and information representing the circuit diagrams as a list (which will be simply referred to herein as a “netlist”). In this preferred embodiment, the IC designing information may include either all of these three types of information or only one or two of them selectively.

In designing an IC using circuit diagrams, the functions of respective blocks of the circuit under design are easily understandable, which is convenient when the IC is made up of a relatively small number of components. However, if the IC should be comprised of a relatively large number of components, then it will be difficult to understand exactly how the respective circuit blocks are associated with each other. Next, in designing an IC using language information, no circuit diagram descriptions are used, thus making the IC rather difficult to understand. Nevertheless, the respective circuit blocks can be understood as functional blocks, thus allowing the designer to design an IC even if he or she cannot understand circuit diagrams. A netlist is a list representing interconnection information between circuits based on the circuit diagrams or language information. Accordingly, in an IC designing system, the netlist is a most extended version of a circuit diagram, i.e., is most suitable for extending an IC.

Each of these three types of information uses a library as a functional unit to make up a circuit. The libraries are classifiable into standard libraries and custom libraries. The standard libraries are provided by the IC designing system. In circuit diagrams, logic circuits such as AND gates and OR gates are standard libraries. The language information also includes standard libraries. That is to say, a standard library may be defined by describing its function in a language. Like the other two types of information, the netlist also includes standard libraries. On the other hand, a custom library means a non-standard library that has been designed by an IC designer (user). The information about the IC that has been newly designed by the design terminal 2 is transmitted to the manager 4 through the Internet 3 and then the newly designed IC information transmitted is added to the custom library designing information at the manager. As a result, the new IC that has been designed by the user is treated as a custom library in the IC designing system.

The IC designing information and newly designed IC information are transmitted from the manager 4 to the design terminal 2, or vice versa, as a transport packet with a format such as that shown in FIG. 2.

For example, a transport packet to be transmitted from the design terminal 2 to the manager 4 so as to send the newly designed IC information preferably includes a header, address information, ID information, newly designed IC information, and a footer as shown in FIG. 2. The header preferably indicates the beginning of the transport packet including the newly designed IC information. The address information preferably specifies the address of the manager 4 as the recipient. The ID information preferably discloses the identity of the design terminal 2 as the sender. And the footer indicates the end of the transport packet including the newly designed IC information. In a packet to be transmitted from the manager 4 to the design terminal 2 on the other hand, the address information specifies the design terminal 2 as the recipient, the ID information discloses the identity of the manager 4 as the sender, and the IC designing information is included instead of the newly designed IC information so as to allow the designer to design his or her own IC based on the IC designing information.

Hereinafter, it will be described how to generate the transport packet of this preferred embodiment. In this preferred embodiment, the transport packet is preferably generated by the communication processing section 22 of the design terminal 2.

In the design terminal 2, the information (including circuit diagrams, language information or netlist) about the IC that has been newly designed by an IC designing section 21 is read out by a timing control section 23 and then passed to the communication processing section 22.

The ID information is preferably stored in a memory (not shown) in the design terminal 2. Examples of the ID information include a maker code showing the manufacturer of the design terminal 2, a type code showing the product number of the design terminal 2 and a serial code showing the serial number of the design terminal 2. Any code may be used as the maker code as long as the code allows the user to identify the manufacturer of the design terminal 2. For example, the maker code may be a character code such as ASCII. However, if there are predetermined standard identification codes for respective manufacturers, then the maker codes preferably comply with those standard codes.

On receiving the newly designed IC information from the timing processing section 23, the communication processing section 22 retrieves the ID information from the memory. Then, the communication processing section 22 adds the ID information, header, address information and footer to the newly designed IC information, thereby generating a transport packet. The transport packet generated in this manner is transmitted to the manager 4 through the Internet.

Alternatively, the transport packet including the newly designed IC information may be generated in any other way. For example, if the memory to store the ID information at the design terminal 2 is a flash memory, the information stored in the flash memory may include the newly designed IC information. To send the transport packet, including the newly designed IC information, more securely, the transport packet may be encrypted in compliance with the secure socket layer (SSL) standard before being transmitted.

In this manner, the transport packet with the newly designed IC information includes the information about the design terminal 2 as the ID information. Thus, the manager 4 can identify who has provided the newly designed IC information to be added to the custom library designing information.

The transport packet including the newly designed IC information is received at the communication processing section 41 of the manager 4 and then passed to a library evaluating section 43. In response, based on the newly designed IC information provided, the library evaluating section 43 evaluates the library (i.e., the newly designed IC). Thereafter, the library evaluating section 43 passes the newly designed IC information, along with the result of its evaluation, to a library database 42. The library database 42 stores the received information (including the evaluation result) as the custom library designing information. In this manner, on receiving the newly designed IC information every time, the manager 4 updates the custom library designing information.

To request the IC designing information, the user at the design terminal 2 may input a download request into the design terminal 2. Then, the download request is transmitted from the communication processing section 22 of the design terminal 2 to the counterpart 41 of the manager 4 over the Internet 3. The communication processing section 41 passes the download request to the timing control section 44. In response to the download request from the design terminal 2, the timing control section 44 reads out the IC designing information (including standard library designing information and custom library designing information) from the library database 42 and outputs the information to the communication processing section 41. The communication processing section 41 adds the header, address information, ID information and footer to the IC designing information, thereby generating a transport packet including the IC designing information such as that shown in FIG. 2. Then, the communication processing section 41 sends out the packet to the design terminal 2 that requested the information over the Internet 3.

It is up to the designer of the newly designed IC to what degree the newly designed IC information (i.e., custom library designing information) transmitted from the design terminal 2 to the manager 4 may be disclosed. As used herein, the “degree of disclosure” refers to the three levels of third party's access control including “disclosed to every user of this IC designing system”, “disclosed to only authorized users” and “concealed from everybody but the designer himself”. Every time the designer has designed a new IC, he or she may add a sign representing to what degree he or she agrees to disclose the newly designed IC information. Alternatively, the designer may also specify his or her agreeable degree of disclosure by an ID information unit. Also, if a newly designed IC was subjected by the design terminal 2 to a simulation during the design process to check out its operability, then testing information (a test vector) may be added to the newly designed IC information for the purpose of simulation.

In the manager 4, the library evaluating section 43 receives the newly designed IC information and makes up a virtual IC on the computer screen through placement and routing processes in accordance with the newly designed IC information. If the testing information is included in the newly designed IC information, then the library evaluating section 43 checks out the operability of the new IC based on the testing information, thereby judging the validity of the IC. If the IC is found operating just as expected, then the IC is judged as a go and the newly designed IC information is added to the custom library designing information. In that case, the custom library designing information is preferably given such a name as clearly showing that the new IC is a go and operating just as originally designed. On the other hand, if the IC is found failing to operate just as expected, then the IC is judged as a no-go. In that case, the information about the no-go IC may or may not be added to the custom library designing information. If that newly designed IC information is added to the custom library designing information, then the information is preferably given such a name as clearly showing that the new IC is a no-go.

However, if no testing information is included in the newly designed IC information, then the library evaluating section 43 does not check out the operability of the new IC and does not judge the validity of the new IC, either. When no operability tests are carried out, the newly designed IC information may or may not be added to the custom library designing information. If the newly designed IC information is added to the custom library designing information, then the newly designed IC information is preferably given such a name as clearly showing that the new IC has gone through no operability tests.

In this manner, the manager 4 evaluates, based on the newly designed IC information provided by the design terminal 2, how reliably the new IC should operate, and records the result of that evaluation, along with the newly designed IC information, as the custom library designing information. The user located at the design terminal 2 can design his or her IC by using the custom library designing information with its reliability taken into full consideration. Also, if the designer uses the custom library designing information, then its testing information is also available for him or her, thus allowing the user to design his or her own IC even more efficiently.

In this IC designing system, part of the custom library designing information must be laid open to general public. However, among the custom library designing information, the custom library circuit diagrams, language information and netlist themselves are preferably concealed from the third party to protect the rights of the designers. Then, even if somebody else tried to make a copy of the designer's new IC, it would be difficult for the follower to make quite the same IC. Particularly when the IC is a big scale, it is normally impossible for the third party to construct a custom library itself based on just a piece of custom library designing information available. Accordingly, the custom library per se can still belong to nobody but the designer himself. It should be noted that that disclosed part of the custom library designing information includes the input/output computer terminal information of the custom library, its circuit size (gate size), information about its exact function, and testing information if necessary.

As described above, it is up to the custom library designer to what degree he or she agrees to allow other IC designers to capitalize on his or her professional knowledge to create an IC library. In any case, however, since every virtual IC must go through a physical LSI manufacturing process as a final step, the IC needs to be subjected to a final test in terms of its layout, for example. At this stage, that third party who has designed an IC by using the custom library designing information may pay the administrator of the manager 4 for the use of the custom library. To protect the custom library designing information, the final test is also preferably done by the manager. Then, the user does not have to carry out high-speed computations using the design terminal, and therefore, may use any inexpensive personal computer as the design terminal. The charge that has been paid for the use of the custom library designing information may be shared by the administrator of the manager 4 and the designer of the custom library. Then, the custom library designer can get paid for disclosing his or her know-how to general public. In this manner, this IC designing system can both encourage a lot of IC designers to provide their custom library designing information and acquire a lot of users looking for the professional custom library designing information.

It should be noted that the respective sections making up the manager 4 or the design terminal 2 may be either functional blocks to be implemented by getting a program in a ROM, RAM or any other storage medium executed by a CPU or other suitable computing means or hardware components performing similar processing. Alternatively, those sections are also implementable by using, in combination, some hardware components to carry out a part of the processing and the computing means to control the hardware components and carry out the other part of the processing. However, as in the preferred embodiment described above, a general-purpose personal computer is preferably used to function as either the manager 4 or the design terminal 2 in accordance with the IC designing and managing program.

That computing means may be either a single microprocessor or a set of multiple processors that are connected together by way of internal buses and various other communication channels so as to carry out the same program in cooperation with each other. In the latter case, the program may be delivered to the respective processors (i.e., computers) either by distributing a storage medium, on which program data, including the program itself and data to create the program, is stored, or by transmitting the program data with wired or wireless communication means.

The storage medium for use to distribute the program data is preferably removable. However, once the program data has been distributed, the storage medium may be either fixed there as it is or removed as well. Furthermore, as long as the program data is stored there, it does not matter whether the storage medium is rewritable (or recordable) or not, whether it is volatile or not, how the data was written there, and what shape the medium has. Examples of preferred storage media include tapes such as a magnetic tape and a cassette tape, magnetic disks such as a floppy disk™ and a hard disk, and optical discs such as a CD-ROM, a magneto-optic disc (MO), a mini disc (MD) and a digital video disc (DVD). Alternatively, the storage medium may also be a card such as an IC card or an optical card or a semiconductor memory such as a masked ROM, an EPROM, an EEPROM or a flash ROM.

The program data may be a code that instructs the computing means the overall procedure of the respective processing steps described above. Also, if a basic program that can carry out part or all of the processing steps by being called in a predetermined order (e.g., an operating system or a library) is already present on the computer, then the overall procedure may be rewritten either partially or entirely by a code or a pointer that instructs the computing means to call the basic program.

The program data may be stored on the storage medium in any format. For example, the program data may be stored there in such a format as to allow the computing means to access and execute the program as if the program data was already stored in a real memory. Alternatively, the program data may also be stored there in another format to be taken before the program data is stored in a real memory and after the program has been installed into a local storage medium (e.g., a real memory or a hard disk) that can be accessed by the computing means at any time. As another alternative, the program data may also be stored there in a format to be adopted before the program is installed from either a network or a removable storage medium into the local storage medium. Furthermore, the program data does not have to be stored as a compiled object code but may also be stored as a source code or an intermediate code to be generated during an interpretation or compiling process. In any case, no matter what format is adopted to store the program data on the storage medium, the same effects are achievable as long as the program data can be converted into a format executable for the computing means by performing extraction, decoding, interpretation, compiling, linking and/or storage to a real memory.

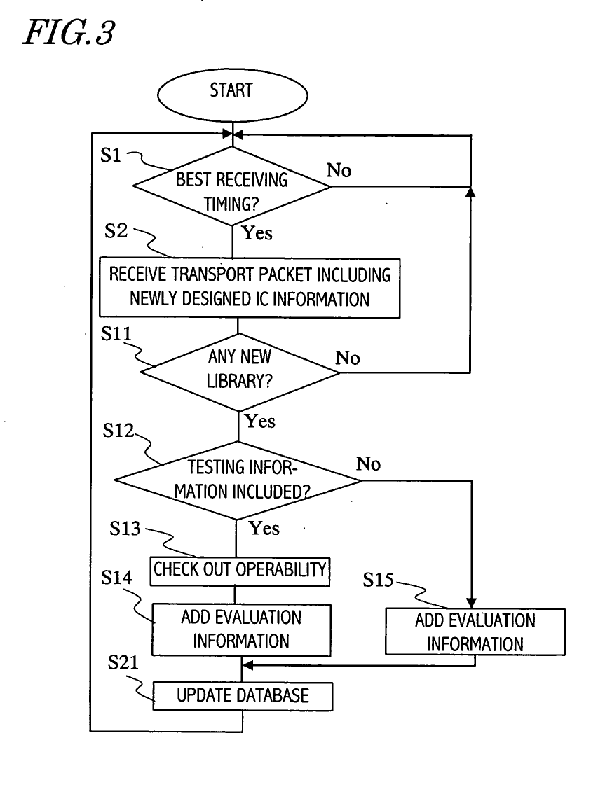

Hereinafter, it will be described with reference to FIG. 3 how the manager 4 operates after the newly designed IC information has been transmitted from the design terminal 2 to the manager 4 and until that information is stored in the library database 42 of the manager 4.

First, in Step S1, the timing control section 44 of the manager 4 determines whether or not the manager 4 is ready to receive the newly designed IC information from the design terminal 2 under management (i.e., whether it is the best time to receive that information or not).

If the answer to the query of Step S1 is YES, then the timing control section 44 instructs the communication processing section 41 to receive the newly designed IC information from the design terminal 2. In accordance with the instruction, the communication processing section 41 receives a transport packet, including the newly designed IC information, from the design terminal 2 in Step S2.

Next, in Step S11, the communication processing section 41 determines whether or not the newly designed IC information received includes information about a totally newly designed library (i.e., whether the new IC designed by the user is based on only the standard or custom library in the IC designing information stored in the manager 4 or any other quite new library). If the answer to the query of Step S11 is YES, then the communication processing section 41 passes the newly designed IC information to the library evaluating section 43. The newly designed IC information preferably includes, but does not always have to include, information representing whether the totally new library is included or not. That quite new library may also be located when the newly designed IC information is extended into a netlist, for example. The netlist may be obtained in the following manner. Since a netlist corresponding to the newly designed IC information is needed, the manager 4 includes netlist converting means (not shown). The newly designed IC information transmitted from the design terminal 2 is converted by this netlist converting means into a netlist. Thereafter, that netlist is sent to the design terminal 2 that has transmitted the newly designed IC information. It should be noted that newly designed IC information including a netlist may sometimes be transmitted from the design terminal 2 to the manager 4. In that case, the manager 4 does not have to perform any netlist conversion.

If the newly designed IC information includes any totally new library, then the manager 4 determines in Step S12 whether or not the newly designed IC information includes additional testing information. If the answer to the query of Step S12 is YES, then the manager 4 checks out the operability of the new IC in Step S13 based on the newly designed IC information including the testing information. The result of the operability checkout is added as evaluation information to the newly designed IC information in Step S14. On the other hand, if the answer to the query of Step S12 is NO, then the manager 4 adds evaluation information representing that the new IC is non-testable to the newly designed IC information in Step S15.

Thereafter, in Step S21, the manager 4 stores (or records) the newly designed IC information, to which the evaluation information has been added, as custom library designing information in the library database 42. In this process step, an appropriate name is given to the newly designed IC information. In Step S21, the library database 42 is updated every time the newly designed IC information is input.

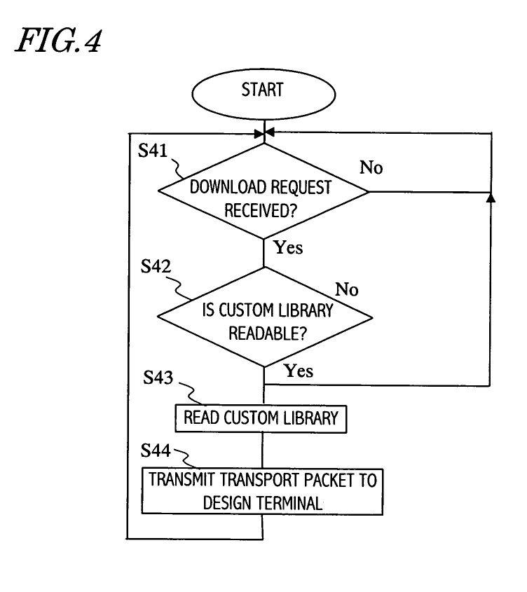

Next, it will be described with reference to FIG. 4 how the manager 4 and design terminal 2 operate in this preferred embodiment after the user has input a request for downloading custom library designing information into the design terminal 2 and until the custom library designing information is transmitted from the manager 4 to the design terminal 2.

The download request that has been input by the user into the design terminal 2 is passed from the timing control section 23 to the communication processing section 22 in the design terminal 2. In response, the communication processing section 22 transmits the download request to the communication processing section 41 of the manager 4 through the Internet 3 (in Step S41).

On receiving the download request, the communication processing section 41 determines, in Step S42, whether or not the custom library designing information requested is a readable library. If the answer to the query of Step S42 is YES (i.e., unless the designer prohibits every user from reading the custom library designing information requested), then the custom library designing information is read out from the library database 42 in Step S43. Then, the communication processing section 41 adds the header, address information, ID information of the design terminal 2 that has requested the custom library designing information, and footer to the custom library designing information retrieved, thereby generating a transport packet. Finally, in Step S44, this transport packet is transmitted from the communication processing section 41 to the design terminal 2 that has requested the custom library designing information.

In the preferred embodiment described above, to transmit the transport packet from the manager 4 to the design terminal 2, or vice versa, more securely, the manager 4 may includes means for identifying the design terminals 2. Particularly in transmitting a transport packet including either the newly designed IC information or the custom library designing information, the manager 4 needs to identify the design terminal 4.

The design terminals 2 may be identified by an electronic authentication number that was uniquely given to each design terminal 2. Alternatively, the design terminals 2 may also be identified by an ID or a PIN that was also uniquely given to each design terminal 2. Optionally, to ensure a higher security level, the electronic authentication number and ID or PIN may be used in combination as well. In any case, if the manager 4 has any of these means for identifying the design terminals 2, the manager 4 is not accessed by any design terminal but authorized design terminals 2. Thus, the manager 4 will not be unnecessarily overloaded.

Various preferred embodiments of the present invention described above provide an IC designing method, which allows an IC designer to design an IC conveniently and efficiently, and a design manager, a design terminal, an IC designing system and a program product for use to carry out such a method. The present invention can be used particularly effectively to design an ASIC.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A method for designing a new IC based on IC designing information transmitted from a manager, the IC designing information including standard library designing information and custom library designing information and being stored in, and managed by, the manager, the method comprising the steps of:
(a) transmitting at least part of the IC designing information, including a portion of the standard library designing information, from the manager to a design terminal through the Internet;
(b) getting the new IC designed by a user located at the design terminal in accordance with the at least part of the IC designing information;
(c) transmitting newly designed IC information, including new IC testing information to evaluate the new IC, from the design terminal to the manager through the Internet;
(d) getting the new IC evaluated by the manager based on the newly designed IC information; and
(e) adding at least part of the newly designed IC information to the custom library designing information that is stored in the manager, thereby updating the custom library designing information.

2. The method of claim 1, wherein the step (c) includes the step of transmitting new IC connection information, and wherein the step (e) includes the step of adding the new IC connection information as custom library connection information to the custom library designing information.

3. The method of claim 1, further comprising, after the step (d), the steps of:
making new IC evaluation information based on a result of the evaluation; and
adding the new IC evaluation information to the newly designed IC information,
wherein the step (e) includes the step of adding the new IC evaluation information as custom library evaluation information to the custom library designing information.

4. The method of claim 1, wherein the step (a) includes the step of transmitting at least a portion of the custom library designing information as the at least part of the IC designing information.

5. The method of claim 1, wherein the step (a) includes the step of transmitting the custom library connection information as the at least part of the IC designing information.

6. The method of claim 3, wherein the step (a) includes the step of transmitting the custom library evaluation information as the at least part of the IC designing information.

7. The method of claim 1, wherein the step (e) includes the step of adding the new IC testing information as custom library testing information to the custom library designing information, and
wherein the step (a) includes the step of transmitting the custom library testing information as the at least part of the IC designing information.

8. The method of claim 4, wherein the step (a) includes the steps of:
making the manager determine whether or not the given design terminal belongs among authorized design terminals and/or whether or not the given user belongs among authorized users; and
transmitting the custom library designing information as the at least part of the IC designing information to the design terminal provided that the given design terminal is identified as one of the authorized design terminals and/or that the given user is identified as one of the authorized users.

9. The method of claim 8, wherein the step of making the manager determine includes the step of identifying the given design terminal by an electronic authentication number that is uniquely given to each authorized design terminal.

10. The method of claim 8, wherein the step of making the manager determine includes the step of identifying the given user by an ID and/or a PIN that are/is uniquely given to each authorized user.

11. The method of claim 8, wherein the step of transmitting the custom library designing information includes the step of narrowing the authorized users to a minimum range.

12. The method of claim 8, wherein if the manager has found the user not belonging among the authorized users, then the step (a) includes the step of transmitting the at least part of the IC designing information not including the custom library designing information at all.

13. The method of claim 9, wherein if the manager has found the user not belonging among the authorized users, then the step (a) includes the step of transmitting the at least part of the IC designing information not including at least a portion of the custom library designing information.

14. The method of claim 9, wherein if the manager has found the user not belonging among the authorized users, then the step (a) includes the step of transmitting the at least part of the IC designing information including the at least a portion of the custom library designing information.

15. The method of claim 14, wherein if the manager has found the user not belonging among the authorized users, then the step (a) includes the step of transmitting the at least part of the IC designing information, including the at least a portion of the custom library designing information, provided that the user pays an administrator of the manager and/or a designer of the custom library for the at least portion of the custom library designing information.

16. The method of claim 15, wherein if the manager has found the user not belonging among the authorized users and if the user is allowed to design the new IC by using the custom library designing information included in the at least part of the IC designing information, the method further includes, after the step (c), the steps of:
determining whether or not the new IC has been designed based on the custom library designing information; and
if the new IC has been designed based on the custom library designing information, alerting the user to pay for the custom library designing information used.

17. A manager for managing IC designing information, the manager comprising:
standard library storing means for storing standard library designing information;
communication processing means for transmitting at least part of the IC designing information to a design terminal, which designs a new IC, through the Internet and receiving design information about the new IC from the design terminal through the Internet, the at least part of the IC designing information including at least a portion of the standard library designing information that has been read out from the standard library storing means, the newly designed IC information including new IC testing information to evaluate the new IC;
library evaluating means for evaluating the new IC according to the newly designed IC information that has been transmitted from the communication processing means;
custom library storing means for storing custom library designing information and for receiving the newly designed IC information from the communication processing means and adding the newly designed IC information to the custom library designing information, thereby updating the custom library designing information; and
managing means for managing the custom library designing information and for determining whether or not at least a portion of the custom library designing information stored in the custom library storing means should be transmitted to the design terminal, wherein if the managing means has decided that the at least the portion of the custom library designing information should be transmitted to the design terminal, then the managing means adds the at least the portion of the custom library designing information to the at least part of the IC designing information by providing the at least the portion of the custom library designing information for the communication processing means.

18. The manager of claim 17, wherein the communication processing means receives a request for the custom library designing information from the design terminal over the Internet and forwards the request to the managing means, and
wherein on receiving the request every time, the managing means determines whether or not at least a portion of the custom library designing information stored in the custom library storing means should be transmitted to the design terminal.

19. A manager for use in the method of claim 1.

20. A design terminal for designing a new IC based on IC designing information transmitted from a manager, the IC designing information including custom library designing information and being stored in and managed by the manager, the design terminal comprising:
means for receiving at least part of the IC designing information from the manager through the Internet;
IC designing means for designing the new IC in accordance with the at least part of the IC designing information; and
means for transmitting newly designed IC information, including new IC testing information to evaluate the new IC that has been designed by the IC designing means, to the manager through the Internet,
wherein the newly designed IC information that has been transmitted to the manager is added to the custom library designing information that is stored in the manager.

21. A design terminal for use in the method of claim 1.

22. A program product defined specially for the purpose of managing IC designing information by making a computer function as:
standard library storing means for storing standard library designing information;
communication processing means for transmitting at least part of the IC designing information to a design terminal, which designs a new IC, through the Internet and receiving design information about the new IC from the design terminal through the Internet, the at least part of the IC designing information including at least a portion of the standard library designing information that has been read out from the standard library storing means, the newly designed IC information including new IC testing information to evaluate the new IC;
library evaluating means for evaluating the new IC according to the newly designed IC information that has been received at the communication processing means;
custom library storing means for storing custom library designing information and for receiving the newly designed IC information from the communication processing means and adding the newly designed IC information to the custom library designing information, thereby updating the custom library designing information; and
managing means for managing the custom library designing information and for determining whether or not at least a portion of the custom library designing information stored in the custom library storing means should be transmitted to the design terminal, wherein if the managing means has decided that the at least the portion of the custom library designing information should be transmitted to the design terminal, then the managing means adds the at least the portion of the custom library designing information to the at least part of the IC designing information by providing the at least the portion of the custom library designing information for the communication processing means.

23. A program product defined specially for the purpose of designing a new IC based on IC designing information, including custom library designing information and being stored in, managed by, and transmitted from, a manager, by making a computer function as:
means for receiving at least part of the IC designing information from the manager through the Internet;
IC designing means for designing the new IC in accordance with the at least part of the IC designing information; and
means for transmitting newly designed IC information, including new IC testing information to evaluate the new IC that has been designed by the IC designing means, to the manager through the Internet,
wherein the newly designed IC information that has been transmitted to the manager is added to the custom library designing information that is stored in the manager.

24. An IC designing system comprising the manager of claim 17 and the design terminal of claim 20.

25. An IC designing system for use in the IC designing method of claim 1.
